(19) United States
(12) Patent Application Publication
(10) Pub. No.: US 2010/0160529 A1
(43) Pub. Date: Jun. 24, 2010

(54) Glass Fiber-Reinforced Polyester Resin Composition and Molded Product Using the Same

(75) Inventors: Ywan-Hee LEE, Uiwang-si (KR); Doo-Han HA, Uiwang-si (KR); Bang-Duk KIM, Uiwang-si (KR); In-Sik SHIM, Uiwang-si (KR); Young-Seok CHANG, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/640,343

(22) Filed: Dec. 17, 2009

(30) Foreign Application Priority Data
Dec. 18, 2008 (KR) 10-2008-0129331
Dec. 16, 2009 (KR) 10-2009-0125503

(51) Int. Cl. C08K 3/40

(52) U.S. Cl. 524/494

(57) ABSTRACT

The present invention relates generally to a glass fiber-reinforced polyester resin composition including: (A) about 30 to about 80 wt % of a polyester resin; (B) about 5 to about 30 wt % of a vinyl-based copolymer; and (C) about 10 to about 50 wt % of a glass fiber with a cross-sectional aspect ratio of about 1.5 or more; and a molded product using the same.

### CROSS REFERENCE TO RELATED APPLICATIONS

This application claims priority to and the benefit of Korean Patent Application No. 10-2008-0129331 filed in the Korean Intellectual Property Office on Dec. 18, 2008, and Korean Patent Application No. 10-2009-0125503 filed in the Korean Intellectual Property Office on Dec. 16, 2009, the entire disclosure of each of which is incorporated herein by reference.

### FIELD OF THE INVENTION

The present application relates to a glass fiber-reinforced polyester resin composition and a molded product made using the same.

### BACKGROUND OF THE INVENTION

Polyester resin has excellent mechanical strength, chemical resistance, electrical characteristics, molding properties, and appearance, and thus has been widely used in various applications. In addition, polyester resin can be molded with various inorganic materials to improve its mechanical strength, which can expand the applications in which such resins can be used.

However, polyester resin is typically crystalline and thus can exhibit poor dimensional stability as compared to a non-crystalline resin. Thus, a molded product formed of a crystalline polyester resin can contract more than a molded product formed of a non-crystalline resin when exposed to temperature changes. Accordingly, there has been much research on mixing a polyester resin with a non-crystalline resin such as a polycarbonate, ABS, ASA, and the like to improve dimensional stability yet also maintain the benefits of the polyester resin. For example, an ASA resin can be mixed with a polyester resin when weather resistance is required.

In general, when glass fiber is used to reinforce a thermoplastic resin, the resulting resin may maintain its molding property, which is attributable to the thermoplastic resin, and may also exhibit improved tensile strength and flexural strength and in particular excellent flexural modulus and heat resistance. Accordingly, a glass reinforced thermoplastic resin may be used to manufacture a product exposed to weight and heat. Due to these characteristics, glass fiber-reinforced thermoplastic resin is widely used in applications such as automobiles, electronic parts, and the like.

However, a glass fiber-reinforcing polyester resin may exhibit different contraction rates in the injecting and vertical directions due to glass fiber orientation that can take place during the injection-molding process. Accordingly, a glass fiber-reinforcing thermoplastic resin may not have the desired dimensions or shape if the molded product is bent or distorted after injection-molding. To address this problem, a mold may need to be modified several times or the injection molding process may require more complex working conditions, which can deteriorate workability.

In addition, adding glass fiber to a polyester resin can decrease the fluidity of the resin. Thus the fiber-reinforced polyester resin can also require increased injection molding temperatures to process the same.

Therefore, a glass fiber-reinforced thermoplastic resin should have improved fluidity and dimensional stability as well maintain tensile strength, flexural strength, flexural modulus, and heat resistance that can result from the addition of glass fiber.

### SUMMARY OF THE INVENTION

One aspect of the present invention provides a glass fiber-reinforced polyester resin composition that can have an excellent balance of dimensional stability, heat resistance, and flexural strength.

Another aspect of the present invention provides a molded product made using the glass fiber-reinforced polyester resin composition.

According to one aspect of the present invention, a glass fiber-reinforced polyester resin composition is provided that includes (A) about 30 to about 80 wt % of a polyester resin; (B) about 5 to about 30 wt % of a vinyl-based copolymer; and (C) about 10 to about 50 wt % of a glass fiber with a cross-sectional aspect ratio of about 1.5 or more.

The polyester resin may be an aromatic polyester resin such as but not limited to a polyethylene terephthalate resin, a polytrimethylene terephthalate resin, a polybutylene terephthalate resin, a polyhexamethylene terephthalate resin, a polycyclohexane dimethylene terephthalate resin, a polyester resin prepared by modifying these resins into a non-crystalline form, or a combination thereof.

The vinyl-based copolymer may include about 65 to about 80 wt % of a first vinyl-based monomer comprising an aromatic vinyl monomer, an acrylic-based monomer, or a combination thereof; and about 20 to about 35 wt % of a second vinyl-based monomer comprising an unsaturated nitrile monomer, an acrylic-based monomer, or a combination thereof.

The glass fiber may have a cross-sectional aspect ratio ranging from about 1.5 to about 8, and may include both glass fiber with a cross-sectional aspect ratio of about 1.5 or more and glass fiber with a cross-sectional aspect ratio of less than about 1.5. The glass fiber with a cross-sectional aspect ratio of less than about 1.5 may be included in an amount of about 1 to about 80 wt % based on the entire weight of the mixture of the glass fiber with a cross-sectional aspect ratio of about 1.5 or more and the glass fiber with a cross-sectional aspect ratio of less than about 1.5.

The glass fiber-reinforced polyester resin composition may further include an impact-reinforcing agent comprising a core-shell copolymer, a linear olefin-based copolymer, or a combination thereof. The impact-reinforcing agent may be included in an amount of about 1 to about 20 parts by weight based on about 100 parts by weight of the glass fiber-reinforced polyester resin composition.

The core-shell copolymer may be prepared by grafting an unsaturated compound comprising a polymer prepared by polymerizing one or more of an acrylic-based monomer, an aromatic vinyl monomer, an unsaturated nitrile monomer or a combination thereof onto a rubber polymer prepared by polymerizing a monomer comprising a diene-based monomer, an acrylic-based monomer, a silicon-based monomer, or a combination thereof. The linear olefin-based copolymer may be a copolymer of an olefin-based monomer comprising ethylene, propylene, butylene, isobutylene, or a combination thereof, and an acrylic-based monomer comprising (meth) acrylic acid alkyl ester, (meth) acrylic acid ester, or a combination thereof.

According to another aspect of the present invention, a product molded of the glass fiber-reinforced polyester resin composition is provided.

Hereinafter, further aspects of the present invention will be described in detail.

### BRIEF DESCRIPTION OF THE DRAWING

FIG. 1 is a schematic view showing the cross-sectional aspect ratio of a glass fiber according to one embodiment.

### DETAILED DESCRIPTION OF THE INVENTION

The present invention will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, unless a definition is otherwise provided, the term “(meth)acrylate” refers to “acrylate” and “methacrylate”. The term “(meth)acrylic acid alkyl ester” refers to “acrylic acid alkyl ester” and “methacrylic acid alkyl ester”, and the term “(meth)acrylic acid ester” refers to “acrylic acid ester” and “methacrylic acid ester”.

According to one embodiment, a glass fiber-reinforced polyester resin composition includes: (A) about 30 to about 80 wt % of a polyester resin; (B) about 5 to about 30 wt % of a vinyl-based copolymer; and (C) about 10 to about 50 wt % of a glass fiber with a cross-sectional aspect ratio of about 1.5 or more.

Exemplary components included in the glass fiber-reinforced polyester resin composition according to embodiments will hereinafter be described in detail. However, these embodiments are only exemplary, and the present invention is not limited thereto.

(A) Polyester Resin

According to one embodiment, the polyester resin can be an aromatic polyester resin which can be produced by condensation-polymerization of terephthalic acid or terephthalic acid alkyl ester and a C2-C10 glycol component. As used herein with reference to the terephthalic acid alkyl ester, the alkyl may be a C1 to C10 alkyl.

Examples of the aromatic polyester resin may include without limitation polyethylene terephthalate resin, polytrimethylene terephthalate resin, polybutylene terephthalate resin, polyhexamethylene terephthalate resin, polycyclohexane dimethylene terephthalate resin, polyester resin modified into a non-crystalline form by mixing these resins with a different monomer, and the like, and combinations thereof. In exemplary embodiments, the aromatic polyester resin may include polyethylene terephthalate resin, polytrimethylene terephthalate resin, polybutylene terephthalate resin, non-crystalline polyethylene terephthalate resin, or a combination thereof.

The polyester resin may have a crystallinity ranging from about 10 to about 60%. The polyester resin may have a specific gravity ranging from about 1.15 to about 1.4 g/cm³ and a melting point ranging from about 210 to about 280° C. When the polyester resin has a suitable intrinsic viscosity as well as a specific gravity and melting point within the above ranges, it can provide excellent mechanical properties and molding properties.

The glass fiber-reinforced polyester resin composition may include the polyester resin in an amount of about 30 to about 80 wt %, for example about 40 to about 60 wt %, based on the entire weight of the glass fiber-reinforced polyester resin composition. When the glass fiber-reinforced polyester resin composition includes the polyester resin in an amount within these ranges, the composition can exhibit excellent strength and impact resistance.

(B) Vinyl-Based Copolymer

The vinyl-based copolymer may include a copolymer including: about 65 to about 80 wt % of a first vinyl-based monomer comprising an aromatic vinyl monomer, an acrylic-based monomer, or a combination thereof; and about 20 to about 35 wt % of a second vinyl-based monomer comprising an unsaturated nitrile monomer, an acrylic-based monomer, or a combination thereof. As used herein, the first and second vinyl-based monomers are different from each other. When the vinyl-based copolymer includes the first and second vinyl-based monomers in an amount within these ranges, it may contribute to improved thermochromism and chemical resistance.

Exemplary aromatic vinyl monomers may include without limitation styrene, C1 to C10 alkyl substituted styrene, halogen substituted styrene, and the like, and combinations thereof. Exemplary alkyl substituted styrene may include without limitation o-ethyl styrene, m-ethyl styrene, p-ethyl styrene, α-methyl styrene, and the like, and combinations thereof.

Exemplary acrylic-based monomers may include without limitation (meth) acrylic acid alkyl esters, (meth) acrylic acid esters, and the like, and combinations thereof. As used herein with reference to the (meth) acrylic acid alkyl esters, the alkyl indicates a C1 to C10 alkyl. Exemplary (meth)acrylic acid alkyl esters may include without limitation methyl(meth)acrylate, ethyl(meth)acrylate, propyl(meth)acrylate, butyl(meth)acrylate, and the like, and combinations thereof. Exemplary (meth) acrylic acid esters may include without limitation (meth)acrylate, and the like.

Exemplary unsaturated nitrile monomers may include without limitation acrylonitrile, methacrylonitrile, ethacrylonitrile, and the like, and combinations thereof.

The vinyl-based copolymer can be produced as a byproduct when a rubber modified vinyl-based graft copolymer is manufactured, such as a core-shell impact-reinforcing agent as described in more detail herein. For example, the vinyl-based copolymer may be produced when an excessive amount of a vinyl-based polymer is grafted into a small amount of a rubber polymer, or when an excess amount of a chain transfer agent, which is used as a molecular weight controlling agent, is used.

Exemplary vinyl-based copolymers may include without limitation a copolymer including styrene, acrylonitrile, and optionally methylmethacrylate; a copolymer including α-methylstyrene, acrylonitrile, and optionally methylmethacrylate; a copolymer including styrene, α-methylstyrene, acrylonitrile, and optionally methylmethacrylate; and the like, and combinations thereof.

The vinyl-based copolymer may be prepared by emulsion polymerization, suspension polymerization, solution polymerization, or bulk polymerization, and may have a weight average molecular weight ranging from about 15,000 to about 300,000 g/mol.

The glass fiber-reinforced polyester resin composition can include the vinyl-based copolymer in an amount of about 5 to about 30 wt %, for example about 10 to about 20 wt %, based on the total weight of the glass fiber-reinforced polyester resin composition. When the glass fiber-reinforced polyester resin composition includes the vinyl-based copolymer in an amount within these ranges, the composition may have excellent compatibility and less property deviation, which can provide excellent heat resistance.

### (C) Glass Fiber

According to one embodiment, the glass fiber may have a flat cross-section and may have a predetermined aspect ratio.

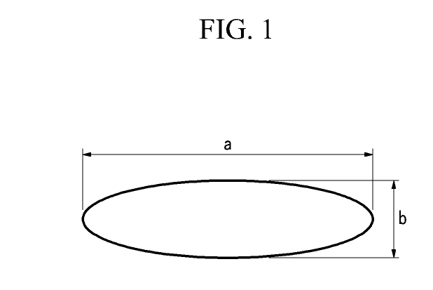

FIG. 1 is a schematic view showing the aspect ratio of the glass fiber according to one embodiment. Referring to FIG. 1, the aspect ratio is defined as a ratio of the shortest diameter (b) in the cross-section of the glass fiber against the longest diameter (a) thereof.

The glass fiber may have an aspect ratio of about 1.5 or more, for example, from about 1.5 to about 8, and as another example, from about 2 to about 6. When glass fiber has a cross-sectional aspect ratio within these ranges, the glass fiber-reinforced polyester resin composition may have a remarkably small degree of fluidity reduction. Thus, it may have little orientation effects dependent on the flow of a polyester resin and can minimize or eliminate distortion of a plastic molded product made from a glass fiber-reinforced polyester resin composition.

The glass fiber may have a length ranging from about 2 to about 13 mm, for example, from about 3 to about 6 mm.

In addition, the glass fiber may have a cross-sectional diameter ranging from about 10 to about 20 μm.

According to one embodiment, the glass fiber with an aspect ratio of about 1.5 or more and a glass fiber with an aspect ratio of less than about 1.5 may be mixed together. As described herein, in such a mixture, the glass fiber with an aspect ratio of about 1.5 or more may be used in an amount ranging from about 20 to about 99 wt %, and the glass fiber with an aspect ratio of less than about 1.5 may be used in an amount ranging from about 1 to about 80 wt %.

When a glass fiber with an aspect ratio of about 1.5 or more and a glass fiber with an aspect ratio of less than about 1.5 are mixed within the aforementioned ratio, the glass fiber-reinforced polyester resin composition may maintain excellent workability and impact resistance.

According to one embodiment, the glass fiber may be coated with a predetermined material on a surface thereof in order to prevent reaction with the polyester resin and improve the degree of impregnation.

The coating material may change overall fluidity, impact strength, and the like of a glass fiber-reinforced polyester resin composition. Suitable materials for coating glass fiber and affecting the fluidity, impact strength, and the like of a glass fiber-reinforced polyester resin composition are well-known to a person of ordinary skill in the art and may be selected without undue experimentation depending on the desired properties of the resultant composition.

The glass fiber-reinforced polyester resin composition may include the glass fiber in an amount of about 10 to about 50 wt %, for example about 10 to about 40 wt %, based on the total weight of the glass fiber-reinforced polyester resin composition. When the glass fiber-reinforced polyester resin composition includes glass fiber in an amount within these ranges, the glass fiber may improve flexural strength and heat resistance of the glass fiber-reinforced polyester resin composition and thus its flow, to thereby provide excellent molding properties.

(D) Impact-Reinforcing Agent

According to one embodiment, a glass fiber-reinforced polyester resin composition may further include an impact-reinforcing agent.

The impact-reinforcing agent may be a core-shell copolymer, a linear olefin-based copolymer, or a combination thereof.

The core-shell copolymer can include a shell formed by grafting an unsaturated monomer onto a rubber core. For example, the core-shell can be formed by grafting an unsaturated compound comprising a polymer formed by polymerizing one or more monomers comprising an acrylic-based monomer, an aromatic vinyl monomer, an unsaturated nitrile monomer, or a combination thereof onto a rubber polymer prepared by polymerizing a monomer comprising a diene-based monomer, an acrylic-based monomer, a silicon-based monomer, or a combination thereof.

Examplary diene-based monomers may include without limitation C4 to C6 butadiene, isoprene, and the like, and combinations thereof. Exemplary rubber polymers prepared by polymerizing a diene-based monomer may include without limitation butadiene rubber, acrylic rubber, styrene/butadiene rubber, acrylonitrile/butadiene rubber, isoprene rubber, ethylene-propylene-diene terpolymer (EPDM), and the like, and combinations thereof.

Exemplary acrylic-based monomers may include without limitation methyl(meth)acrylate, ethyl(meth)acrylate, n-propyl(meth)acrylate, n-butyl(meth)acrylate, hexyl(meth)acrylate, 2-ethylhexyl(meth)acrylate, and the like, and combinations thereof. A hardener or curing agent such as ethylene glycol di(meth)acrylate, propylene glycol di(meth)acrylate, 1,3-butylene glycol di(meth)acrylate, 1,4-butylene glycol di(meth)acrylate, allyl(meth)acrylate, triallylcyanurate, and the like, or a combination thereof can be used.

Exemplary silicon-based monomers may include without limitation cyclosiloxane compounds such as hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like and combinations thereof. A hardener or curing agent such as but not limited to trimethoxymethylsilane, triethoxyphenylsilane, tetramethoxysilane, tetraethoxysilane, and the like, or a combination thereof can be used.

The rubber polymer having a rubber average particle diameter ranging from about 0.4 to about 1 μm may be beneficial in terms of a balance of impact resistance and coloring.

The rubber polymer may be included in an amount of about 20 to about 80 wt % based on the entire weight of the core-shell copolymer. When the core-shell copolymer includes the rubber polymer in an amount within this range, the core-shell copolymer can maximize the impact reinforcing effect and heat resistance improvement, and remarkably improve fluidity.

Among the unsaturated compounds, exemplary acrylic-based monomers can include without limitation (meth)acrylic acid alkyl esters, (meth)acrylic acid esters, and the like, and combinations thereof. As used herein with reference to (meth)acrylic acid alkyl esters, the alkyl indicates a C1 to C10 alkyl. Exemplary (meth)acrylic acid alkyl esters may include without limitation methyl(meth)acrylate, ethyl(meth)acrylate, propyl(meth)acrylate, butyl(meth)acrylate, and the like, and combinations thereof. Exemplary (meth) acrylic acid esters may include without limitation (meth)acrylate, and the like.

Among the unsaturated compounds, exemplary aromatic vinyl monomers may include without limitation styrene, C1 to C10 alkyl substituted styrene, halogen substituted styrene, and the like, and combinations thereof. Exemplary alkyl substituted styrene may include without limitation o-ethyl styrene, m-ethyl styrene, p-ethyl styrene, alphamethyl styrene, and the like, and combinations thereof.

Among the unsaturated compounds, exemplary unsaturated nitrile monomers may include without limitation acrylonitrile, methacrylonitrile, ethacrylonitrile, and the like, and combinations thereof.

An exemplary unsaturated compound comprising a polymer prepared from more than one monomer may include polymethylmethacrylate.

The core-shell copolymer may have an average particle size ranging from about 0.1 to about 10 μm. When the core-shell copolymer has an average particle size within this range, it may be well-dispersed into a polyester matrix. Accordingly, when the composition is exposed to an external impact, it may easily absorb the impact to increase the impact-reinforcing effect.

The linear olefin-based copolymer may include a copolymer of an olefin-based monomer and an acrylic-based monomer.

Exemplary olefin-based monomers may include without limitation ethylene, propylene, butylene, isobutylene, and the like, and combinations thereof.

Exemplary acrylic-based monomers may include without limitation (meth)acrylic acid alkyl esters, (meth)acrylic acid esters, and the like, and combinations thereof. As used herein with reference to the (meth)acrylic acid alkyl ester, the alkyl indicates a C1 to C10 alkyl. Exemplary (meth)acrylic acid alkyl esters may include without limitation methyl(meth)acrylate, ethyl(meth)acrylate, propyl(meth)acrylate, butyl(meth)acrylate, and the like, and combinations thereof. Exemplary (meth) acrylic acid esters may include without limitation (meth)acrylate, and the like. The linear olefin-based copolymer may be prepared using a Ziegler-Natta catalyst, which is a common olefin polymerization catalyst. In order to have a more selective structure, the linear olefin-based copolymer may alternatively be prepared using a metallocene-based catalyst.

According to one embodiment, an impact-reinforcing agent may not include a functional group in order to prevent color change during the injection stay and to accomplish excellent injection appearance.

The glass fiber-reinforced polyester resin composition may include the impact-reinforcing agent in an amount of about 1 to about 20 parts by weight, for example about 5 to about 15 parts by weight, based on about 100 parts by weight of the glass fiber-reinforced polyester resin composition. When an impact-reinforcing agent is included within these ranges, it may maximize the impact-reinforcing effect, increase heat resistance increase and improve fluidity, which can improve injection molding properties.

(E) Other Additives

According to one embodiment, the glass fiber-reinforced polyester resin composition may further include one or more additives.

Examples of the additive(s) may include without limitation antibacterial agents, heat stabilizers, antioxidants, release agents, light stabilizers, compatibilizers, inorganic material additives, surfactants, coupling agents, plasticizers, admixtures, stabilizers, lubricants, antistatic agents, flame proofing agents, weather-resistance agents, colorants, ultraviolet (UV) blocking agents, filler, nucleating agents, adhesion aids, adhesives, and the like, and combinations thereof.

Exemplary antioxidants may include without limitation phenol-type antioxidants, phosphite-type antioxidants, thioether-type antioxidants, amine-type antioxidants, and the like, and combinations thereof. Exemplary release agents may include without limitation fluorine-containing polymers, silicone oils, metal salts of stearic acid, metal salts of montanic acid, montanic acid ester waxes, polyethylene waxes, and the like, and combinations thereof. Exemplary weather-resistance agents may include without limitation benzophenone-type weather-resistance agents, amine-type weather-resistance agents, and the like, and combinations thereof. Exemplary colorants may include without limitation dyes, pigments, and the like, and combinations thereof. Exemplary ultraviolet (UV) blocking agents may include without limitation titanium oxide (TiO₂), carbon black, and the like, and combinations thereof. Exemplary filler may include without limitation glass fiber, carbon fiber, silica, mica, alumina, clay, calcium carbonate, sulfuric acid calcium, glass beads, and the like, and combinations thereof. When filler is included, it may improve properties such as mechanical strength, heat resistance, and the like. Exemplary nucleating agents may include without limitation talc, clay, and the like, and combinations thereof.

According to one embodiment, the glass fiber-reinforced polyester resin composition may include an additive in an amount of about 50 parts by weight or less based on about 100 parts by weight of the glass fiber-reinforced polyester resin composition. When an additive is included in an amount within this range, it may accomplish a desired effect depending on the use of each and thus can provide excellent mechanical properties and improved surface appearance.

According to one embodiment, a glass fiber-reinforced polyester resin composition can be prepared using well-known methods. For example, the aforementioned components and optionally additives can be mixed together and melt-extruded in an extruder to prepare pellets.

Another embodiment of the invention provides a product molded using the glass fiber-reinforced polyester resin composition. The molded product can include the polyester resin in which glass fiber with an aspect ratio of about 1.5 or more is dispersed.

This plastic molded product can exhibit various advantageous properties such as improved tensile strength and flexural strength, and in particular, excellent heat resistance, and thus may be used for a part subject to constant weight and heat.

In addition, when a glass fiber with a cross-sectional aspect ratio of about 1.5 or more is added, the glass fiber-reinforced polyester resin composition may have sharply reduced fluidity compared with a conventional glass fiber-reinforced polyester resin composition. Accordingly, a plastic molded product may be prevented from being bent or distorted during the manufacturing process.

Therefore, this plastic product may be useful in various products requiring precise dimensional stability, for example, fine electronic parts, fine auto parts, and the like.

The following examples illustrate this disclosure in more detail. However, they are exemplary embodiments of this disclosure and are not limiting.

### EXAMPLES

A glass fiber-reinforced polyester resin composition according to one embodiment includes each component as follows.

(A) Polyester Resin

Polybutylene terephthalate having a specific gravity of 1.31 g/cm³, an intrinsic viscosity of 0.83, and a melting point of 228° C. available from SHINKONG Co. under the name Shinite K001 is used as the polyester resin.

(B) Vinyl-Based Copolymer

A SAN copolymer resin is prepared by adding 0.17 parts by weight of azobisisobutyronitrile, 0.4 parts by weight of a t-dodecyl mercaptan chain-transfer agent, and 0.5 parts by weight of tricalcium phosphate to a mixture of 71.5 parts by weight of styrene, 28.5 parts by weight of acrylonitrile, and 120 parts by weight of deionized water, and then suspension-polymerizing the resulting mixture at 75° C. for 5 hours. The resulting copolymer is washed, dehydrated, and dried, preparing a powder-type SAN copolymer resin.

(C) Glass Fiber

CSG 3PA-820 made by Nitto Boseki Co., Ltd., as a 3 mm-long glass fiber with a (C-1) cross-sectional aspect ratio of 4 (longest diameter of 28 μm, shortest diameter of 7 μm) is used.

CS321-EC10-3 made by KCC corporation, which has a length of 3 mm, a diameter of 13 μm, and a C-2 cross-sectional aspect ratio of 1 is used.

(D) Impact-Reinforcing Agent

A core-shell copolymer prepared by grafting a copolymer of acrylonitrile and styrene onto acrylate is used. The copolymer has an average particle size of 3 μm.

### Examples 1 to 8 and Comparative Examples 1 to 3

The aforementioned components are mixed according to the amounts indicated in the following Table 1, and the mixture is prepared into pellets by using a twin screw extruder with 1)=45 mm. A polyester resin, an impact-reinforcing agent, and a vinyl-based copolymer are put in a main feeder, and glass fiber is put in a side feeder.

Experimental Example

The pellets according to Examples 1 to 8 and Comparative Examples 1 to 3 are dried at 110° C. for 3 hours or more, and then extruded in a 10 oz extruder set at a shaping temperature of 200 to 300° C. and a molding temperature of 60 to 100° C., to prepare a specimen. The properties of the specimens are measured in accordance with the following methods. The results are provided in the following Table 1.

Melt flow rate: measured according to ASTM D1238 at a temperature of 250° C. using a weight of 5 kg to measure mass of a resin flowing out for 1 minute.

(2) Flexural strength: measured according to ASTM 790.

(3) Heat resistance: measured according to ASTM D648.

(4) Shrinkage ratio: a 6″×6″ and ⅛″-thick film gate mold is maintained at 80° C. and injection-molded in a 10 oz injection-molder with power of 95%, and then allowed to stand without any external power for 24 hours in a constant temperature/humidity room set to have a temperature of 23° C. and humidity of 50%. Then, shrinkage rate in the Transverse Direction (TD) perpendicular to the Machine Direction (MD) and flow, which is a back flow direction of the specimen, are measured.

TABLE 1

| | | Examples | | | | | | | | Comparative Examples | | |
|---|---|---|---|---|---|---|---|---|---|---|---|---|
| | | 1 | 2 | 3 | 4 | 5 | 6 | 7 | 8 | 1 | 2 | 3 |
| (A) polyester | | 50 | 50 | 50 | 50 | 55 | 55 | 55 | 55 | 80 | 50 | 55 |
| resin (wt %) | | | | | | | | | | | | |
| (B) vinyl- | | 10 | 10 | 30 | 30 | 15 | 15 | 15 | 15 | — | 40 | 15 |
| based | | | | | | | | | | | | |
| copolymer | | | | | | | | | | | | |
| (wt %) | | | | | | | | | | | | |
| (C) glass | C-1 | 40 | 40 | 20 | 20 | 30 | 25 | 15 | 10 | 20 | 10 | — |
| fiber | C-2 | — | — | — | — | — | 5 | 15 | 20 | — | — | 30 |
| (wt %) | | | | | | | | | | | | |

| | | | | | | | | | | | |
|---|---|---|---|---|---|---|---|---|---|---|---|
| (D) impact- | — | 15 | — | 15 | 10 | 10 | 10 | 10 | — | — | 10 |
| reinforcing | | | | | | | | | | | |
| agent | | | | | | | | | | | |
| (parts by | | | | | | | | | | | |
| weight*) | | | | | | | | | | | |
| melt flow | 28 | 21 | 40 | 25 | 30 | 31 | 32 | 30 | 32 | 30 | 30 |
| rate(MFR) | | | | | | | | | | | |
| (g/1 minute) | | | | | | | | | | | |
| flexural | 110,000 | 105,000 | 59,000 | 54,000 | 78,000 | 77,000 | 76,000 | 73,000 | 53,000 | 43,000 | 77,000 |
| strength | | | | | | | | | | | |
| (kgf/cm²) | | | | | | | | | | | |
| heat | 230 | 210 | 193 | 185 | 194 | 193 | 189 | 189 | 202 | 140 | 193 |
| resistance (° C.) | | | | | | | | | | | |
| shrinkage | MD: 0.35 | MD: 0.34 | MD: 0.39 | MD: 0.39 | MD: 0.28 | MD: 0.30 | MD: 0.29 | MD: 0.30 | MD: 0.45 | MD: 0.38 | MD: 0.31 |
| ratio (%) | TD: 0.72 | TD: 0.70 | TD: 0.82 | TD: 0.85 | TD: 0.68 | TD: 0.75 | TD: 0.80 | TD: 0.85 | TD: 0.93 | TD: 0.98 | TD: 0.94 |

*parts by weight: based on 100 parts by weight of (A) a polyester resin, (B) a vinyl-based copolymer, and (C) a glass fiber.

Referring to Table 1, the compositions including a polyester resin, a vinyl-based copolymer, and a glass fiber with a cross-sectional aspect ratio of about 1.5 or more according to Examples 1 to 8 exhibit an excellent balance of properties such as fluidity, flexural strength, heat resistance, and dimensional stability compared with Comparative Example 1 (composition including no vinyl-based copolymer), Comparative Example 2 (composition including a vinyl-based copolymer in an amount outside of the range of the invention) and Comparative Example 3 (composition including no glass fiber with a cross-sectional aspect ratio of about 1.5 or more).

In particular, Comparative Example 3 (the composition including glass fiber with a cross-sectional aspect ratio of less than about 1.5) has a high shrinkage ratio and thus deteriorated dimensional stability.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A glass fiber-reinforced polyester resin composition comprising:
(A) about 30 to about 80 wt % of a polyester resin;
(B) about 5 to about 30 wt % of a vinyl-based copolymer; and
(C) about 10 to about 50 wt % of a glass fiber with a cross-sectional aspect ratio of about 1.5 or more.

2. The glass fiber-reinforced polyester resin composition of claim 1, wherein the polyester resin is an aromatic polyester resin comprising polyethylene terephthalate resin, polytrimethylene terephthalate resin, polybutylene terephthalate resin, polyhexamethylene terephthalate resin, polycyclohexane dimethylene terephthalate resin, polyester resin prepared by modifying these resins into a non-crystalline form, or a combination thereof.

3. The glass fiber-reinforced polyester resin composition of claim 1, wherein the vinyl-based copolymer comprises about 65 to about 80 wt % of a first vinyl-based monomer comprising an aromatic vinyl monomer, an acrylic-based monomer, or a combination thereof; and about 20 to about 35 wt % of a second vinyl-based monomer comprising an unsaturated nitrile monomer, an acrylic-based monomer, or a combination thereof.

4. The glass fiber-reinforced polyester resin composition of claim 1, wherein the glass fiber has a cross-sectional aspect ratio ranging from about 1.5 to about 8.

5. The glass fiber-reinforced polyester resin composition of claim 1, wherein the glass fiber comprises a mixture of a glass fiber with a cross-sectional aspect ratio of about 1.5 or more and a glass fiber with a cross-sectional aspect ratio of less than about 1.5.

6. The glass fiber-reinforced polyester resin composition of claim 5, wherein the mixture comprises the glass fiber with a cross-sectional aspect ratio of less than about 1.5 in an amount of about 1 to about 80 wt % based on the total weight of the mixture.

7. The glass fiber-reinforced polyester resin composition of claim 1, wherein the glass fiber-reinforced polyester resin composition further comprises an impact-reinforcing agent comprising a core-shell copolymer, a linear olefin-based copolymer, or a combination thereof.

8. The glass fiber-reinforced polyester resin composition of claim 7, comprising the impact-reinforcing agent in an amount of about 1 to about 20 parts by weight based on about 100 parts by weight of the glass fiber-reinforced polyester resin composition.

9. The glass fiber-reinforced polyester resin composition of claim 7, wherein the core-shell copolymer is prepared by grafting an unsaturated compound comprising an acrylic-based monomer, an aromatic vinyl monomer, an unsaturated nitrile monomer, a polymer formed of more than one of said monomers, or a combination thereof onto a rubber polymer prepared by polymerizing a monomer comprising a diene-based monomer, an acrylic-based monomer, a silicon-based monomer, or a combination thereof.

10. The glass fiber-reinforced polyester resin composition of claim 7, wherein the linear olefin-based copolymer comprises an olefin-based monomer comprising ethylene, propylene, butylene, isobutylene, or a combination thereof; and an acrylic-based monomer comprising (meth)acrylic acid alkyl ester, (meth)acrylic acid ester, or a combination thereof.

11. A product molded of the glass fiber-reinforced polyester resin composition of claim 1.
